(19) United States
(12) Patent Application Publication
(10) Pub. No.: US 2013/0166645 A1
(43) Pub. Date: Jun. 27, 2013

(54) Flexible Content-Consumer and Content-Producer Rendezvous

(71) Applicant: Michael C. WESTBY, Happy Valley, OR (US)

(72) Inventor: Michael C. WESTBY, Happy Valley, OR (US)

(21) Appl. No.: 13/337,264

(22) Filed: Dec. 26, 2011

(51) Int. Cl. G06F 15/16

(52) U.S. Cl. 709/204

(57) ABSTRACT

A scheduling and multimedia delivery system for announcing, subscribing to and delivering live audio, video, audio/video, text or combination reports helps reporters and performers build an audience of viewers interested in participating in an interactive presentation. Viewers can also find archived copies of previous reports. Systems offering the data processing facilities to support such services are also described and claimed.

### CONTINUITY AND CLAIM OF PRIORITY

This is an original U.S. patent application.

### FIELD

The invention relates to resource planning, allocation or scheduling for a business operation. More specifically, the invention relates to systems and methods for performing online scheduling and matching of a performer or content producer and one or more interested audience members who wish to view the performance.

### BACKGROUND

A wide variety of traditional media have analogues in the online world: newspapers have news websites, bulletin boards have weblogs, and television shows have on-demand video streaming. For any particular real-world interaction, a virtual version can be imagined, though the limitations of the latter may make it vastly inferior to the real thing.

On the other hand, some virtual services accomplish things that would be difficult or impossible in the real world. For example, a simple website can help a writer or artist present his work to a world-wide audience, and on-demand streaming media allows people with busy schedules to watch programs that they might otherwise miss.

Online service delivery techniques loosen or remove many real-world, physical or financial constraints, allowing people to interact in new ways. And many of these interactions turn out to be popular and/or valuable. New ideas for structuring virtual or virtual/physical-hybrid interactions and systems to support their delivery may be of great utility.

### SUMMARY

An online reservation system schedules live multimedia presentations proposed by one system user and records reservations from other users to view selected presentations. The system receives the presentation data at the scheduled time and delivers it to the live attendees, and may save the data for later viewing by other interested parties.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flowchart outlining a central workflow of an embodiment.

FIG. 2 is an example system diagram.

### DETAILED DESCRIPTION

Embodiments of the invention operate in the general area of social media, and more specifically live-blogging, where an individual uses online social-media services to transmit information about an event in progress to an audience of “followers.” An embodiment improves ad-hoc live blogs by providing services and structures to help content producers (“performers” or “reporters”) attract interested viewers and deliver compelling live content to them. The reported-on event may be spontaneous (e.g., something that occurs where the content producer happens to be), scheduled but carried out by others (e.g., a speech or concert where the content producer is an audience member), or self-planned (e.g., a presentation that the content producer plans, creates and narrates herself). The following descriptions and explanations will focus on a preferred embodiment of the system implemented around a multi-faceted website that provides sophisticated planning and scheduling resources, with a content-delivery infrastructure to receive the performance data (e.g., from a mobile device or system operated by the reporter) and retransmit it to the audience members.

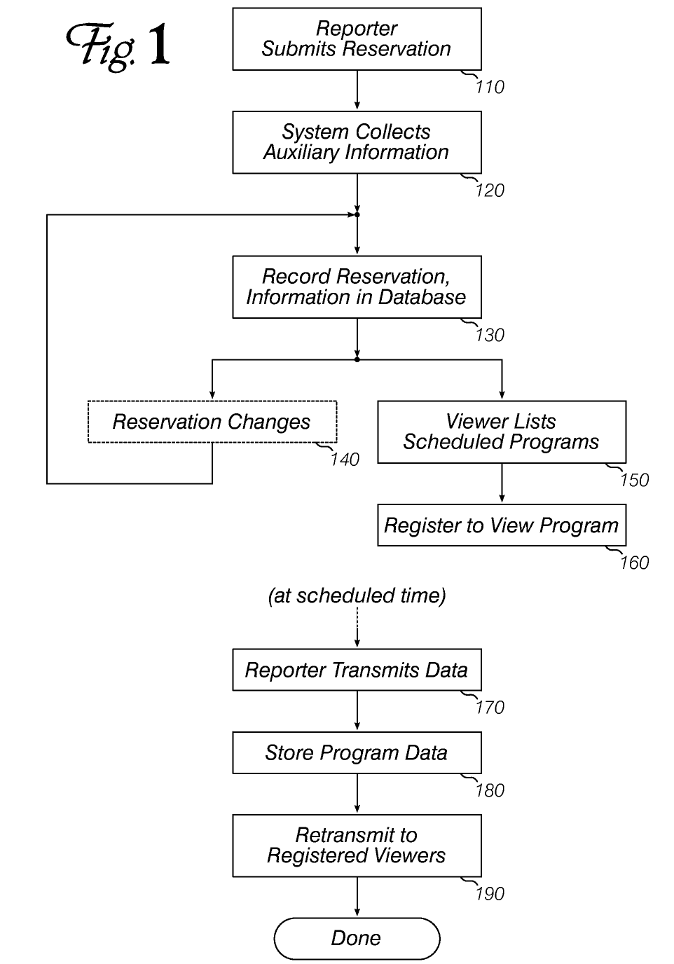

FIG. 1 is a flow chart outlining a central workflow facilitated by an embodiment. At 110, a reporter submits a reservation to indicate that she plans to transmit a live report about a topic on a particular date and time. The system may collect additional information (120), such as a synopsis of the report, media expected to be provided (e.g., audio, video, text, still images, pre-recorded items, etc.) The reservation and associated information is recorded in a scheduling database (130). After making the reservation, the reporter may submit changes, additions or deletions, or even cancel the reservation before the scheduled performance (140).

Separately, a potential viewer may visit the website and access a list of scheduled programs (150). If he is interested in one, he may register to view it (160). (Other potential viewers may do the same: the website will accept registrations from multiple viewers to watch the program.) Later, when the scheduled time arrives, the reporter begins transmitting her report (170). The system may archive the data for future playback (180) and also transmit it in real time to viewers who registered to watch (190).

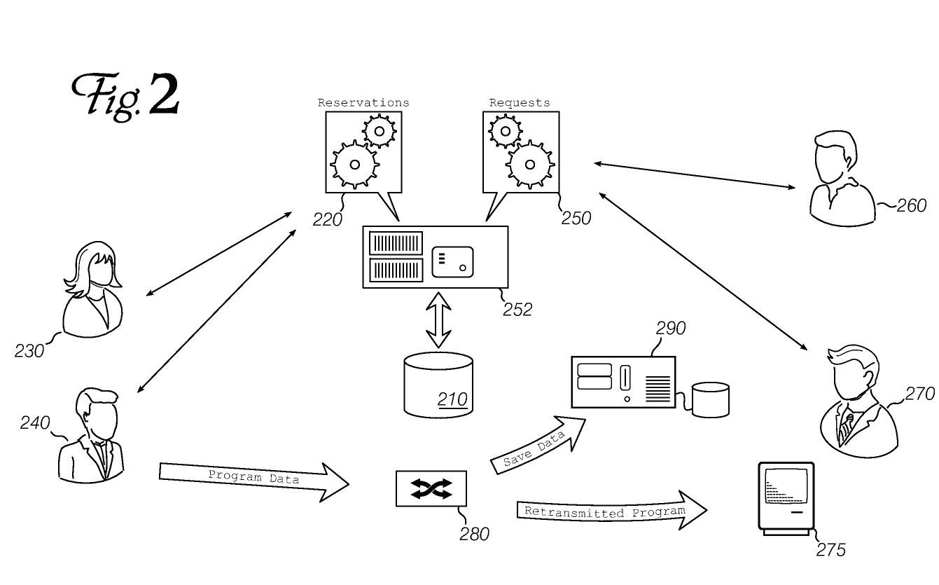

FIG. 2 shows, in functional form, components of a system to support operations according to an embodiment of the invention. The central feature of the system is a scheduling database 210, which stores information about programs that reporters have proposed to deliver. The information in database 210 may include the time, date and location of the report, the reporter's name and curriculum vitae, the topic and background information about the report, and so on. A reservation system 220 interacts with reporters 230, 240 to enter new reservations into database 210 or to change already-entered reservations. Reservation system 220 may be, for example, a website or a portion thereof, and reporters may interact with it using a computer web browser, a mobile device application, or some analogous interface.

Similar to the reservation system 220, a request system 250 interacts with viewers 260, 270, who may search the scheduling database 210 to find programs that interest them, and sign up to view those programs when they are scheduled to be transmitted. Request system 250 may also be implemented as a website; in fact, in one preferred embodiment, the reservation and request systems are simply different areas of the same website. Reservation system 220 and request system 250 may be implemented on a single computer server 252, or their functions may be distributed over several different machines.

The system also comprises a repeater function 280, which receives information (program data) transmitted by a reporter at the scheduled time of a report, and retransmits it to the viewers. For example, viewer 270 may receive audio, video and/or text data from reporter 240 via repeater 280, and watch the program live in real time on his local personal computer 275, or on some other device (not shown) that the viewer has with him when the scheduled program time arrives. The system may provide a back channel to permit viewer 270 to send text messages, audio or even video to reporter 240. This back channel may permit viewers to ask questions or to request additional views or coverage of an aspect of the report subject.

The repeater function 280 may also supply the program information (including back-channel information from one or many viewers) to an archiving system 290, where it can be stored for later playback to viewers who were unable to attend the live presentation, or who only learned about the program after the live presentation had concluded. Repeater 280 may also be implemented on the same computer server 252 as the reservation and request functions, or on different (or multiple) servers to provide better data delivery to viewers and recorders. All the computers, phones and other devices that participate in this system may communicate over a distributed data network such as the Internet, using legacy protocols or custom protocols.

Operations of an embodiment of the invention can be divided temporally into two phases: scheduling and preparation for a report, and delivering the report. In preferred embodiments, the scheduling and preparation are effectively handled by features and services of an Internet web site. The web site may be divided into a number of primary sections, each with related sub-sections. Primary sections may include without limitation:
Login
Create a new account
Schedule a report
View a report
List featured and/or popular reports

Anyone may visit the website and register to transmit a new report, either to begin immediately or at a predetermined future time. Such a registrant is called a “reporter.” The website provides functions to help the reporter publicize her report and to assemble an audience of viewers. For example, the reporter may be prompted to enter metadata defining her report, including without limitation:
Title
Description
Planned date
Expected duration
Location

A report may comprise a series of episodes. For example, a reporter planning to visit a vacation or tourist destination may register her plans to transmit several hour-long segments from different attractions at the destination, perhaps even occurring over several clays. Other reporters may announce their intent to attend scheduled events of general or special interest, such as political conventions, court proceedings or press conferences.

The reporter may set other parameters for the upcoming report, including without limitation:
Limit viewers to a subset of website users (“private reports”)
Allow (or block) interactive commenting by viewers during the report
Enable (or disable) archiving
Show (or hide) reporter biography
Show (or hide) reporter picture

Once the report parameters and metadata have been entered, the reporter posts the information to the scheduling database, where it may be made available to other users looking for information about the proposed topic (or for reports about anything from that particular reporter). In one embodiment, the reporter is encouraged to categorize or classify her report so that it is easier for interested viewers to find. For example, a portion of a category hierarchy might be:
Adventure Vacations
Bike Rides
City Tours
   Domestic
   Foreign
Family Vacations
   Disney Theme Parks
   National Parks
      United States
         Alaska
         California
         Wyoming
      Canada

The portion of the web site that the reporter interacts with may allow the reporter to modify or even cancel a scheduled report.

A second portion of the website (also generally used in the scheduling and preparation phase) is directed at helping would-be viewers find programs that interest them. Viewers may be invited to register before using the site; this may allow the development of profile information to assist in the automatic identification of programs that may be of interest. Some embodiments may require registration prior to viewing, while others may make such registration optional.

A viewer may peruse a “Main Menu” screen of the website (or a similar listing displayed on a mobile device). The menu may offer a plurality of top-level categories, such as:
Upcoming Reports
Live Reports (currently being transmitted)
Archived Reports (previously transmitted)

One function of the viewer's portion of the website is to collect expressions of interest in upcoming reports. Interested viewers will comprise a live audience for the reporter when the report is transmitted. The system may allow a reporter to see how many viewers have signed up to watch her report, and may facilitate pre-report communication so that viewers can ask questions about the planned program or request that certain topics be given particular attention.

The viewer's portion of the web site may also allow searching by category (e.g., the hierarchical category discussed above), by reporter name, keyword, date, time and/or location. The search may produce a list of report titles and summary information, with further detail available to interested viewers. Standard website techniques such as hyperlinks and pop-up windows can be used to present additional information, such as the metadata entered by the reporter when the report was scheduled.

The system may allow a viewer to construct a “playlist” of reports and programs, and may send reminders by email or text message so that the viewer will not miss a live report he wanted to watch. Reminders may also be entered into a calendar system. The playlist feature may automatically convert reservations for live events into links to the archived version of the event.

A viewer-to-viewer or viewer-to-reporter messaging function may allow viewers to discuss upcoming programs among themselves or with the reporter, or to review a program's quality for subsequent viewers who may watch an archived copy.

Generally speaking, the website provides a way for reporters and viewers to schedule and meet for a live event, where the reporter generally provides information (video, audio, text, images, etc.) to the viewers, but the viewers also may respond to the reporter substantially in real time.

A viewer may sign up for reports that are scheduled concurrently (or with at least some temporal overlap). The system may list such reports in an “upcoming” queue chronologically based on starting dates, and may provide in-program notices when an overlapping program starts while the viewer is watching an earlier program. As mentioned above, a reporter may mark a report as “private” or “protected” to prevent access by unrelated viewers. For example, a reporter delivering a program about a family vacation may only want friends and family members to see it. A “by request” system can be provided, where a viewer who would like to watch a program must obtain permission or approval from the reporter before being allowed to participate in the live report.

The second temporal phase of operations according to an embodiment occurs when the reporter begins transmitting her report at the scheduled time. Many embodiments will provide a mobile-phone app to integrate and transmit video, audio and text to the repeating station for retransmission to live viewers and (optionally) the archiving system. This offers an accessible, modest cost and complexity way for reporters to begin offering live content. Some systems may also accept (and retransmit) higher-quality, higher-bandwidth streams produced by professional-grade audio and video equipment. A sophisticated user may have her own production crew with multiple cameras, feeds and reporters all working to deliver a polished live, interactive program.

With the basic mobile-phone application, the reporter may log into the website at the scheduled time (perhaps after receiving a reminder by email, text message or synthesized voice call) and begin the report simply by activating a “Report Now” control of the user interface. The application may activate the phone's video and audio capture features, sending the data to the repeating station. The user interface may display information about the makeup of the live audience, and may also present text, audio or video from audience members via the back channel. The reporting device interface may provide controls to allow the reporter to send, without limitation, information such as:
Text
Photos (stored or newly captured)
Muted audio (or filler audio)
Audio (live or prerecorded)
   In some embodiments a “laugh track” control may be provided
Twitter messages (“tweets”)
Facebook messages
Map (GPS) location
On/Off-Air (pause)

In addition, the reporting interface may allow the reporter to change her profile or program settings during the report.

The interface through which a viewer watches a live (or archived) report may be similar to well-known audio/video players. A text-chat sidebar may allow viewers to send messages back to the reporter, or to other live viewers. Users watching an archived program will not be able to interact with the reporter, but may be able to communicate with other viewers watching the same archived program. Such communication may be in real time, if the viewers are watching concurrently; or may take the form of leaving comments during one viewing to be displayed during a later viewing.

Finally, an embodiment may collect information about the program and its viewers (both live and replay viewers) and provide that information to the reporter, viewers and/or third parties (e.g., advertisers) who might like to know how many people watched, when they began watching and whether they departed before the end of the program, how many interactions occurred between reporter and viewers and among viewers, etc. This information may be stored in a database and queried via an administrative reporting interface.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer or device selectively activated or reconfigured by a computer program stored in the computer (device). Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that scheduling, receiving and republishing multimedia reports can also be achieved by software and hardware that distribute the functions of embodiments of this invention differently than herein described. Such variations and implementations are understood to be captured according to the following claims.

I claim:

1. A method for assembling an audience comprising:
accepting a reservation from a reporter to indicate that the reporter will transmit information pertaining to a topic;
accepting a reservation from at least one viewer to indicate that the at least one viewer wishes to receive the information pertaining to the topic;
receiving the information pertaining to the topic from the reporter; and
transmitting the information to the at least one viewer.

2. The method of claim 1 wherein the accepting the reservation from the reporter comprises:
receiving the reservation from the reporter at a first time, said reservation to indicate a second, later time at which the reporter will transmit the information; and wherein accepting the reservation from the at least one viewer comprises:
receiving the reservation from the at least one viewer after the first time and before the second, later time.

3. The method of claim 2, further comprising:
transmitting a count of reservations received from the at least one viewer to the reporter before the second, later time.

4. The method of claim 2, further comprising:
transmitting at least one reminder message to the at least one viewer after the first time and before the second, later time.

5. The method of claim 1, further comprising:
saving the information pertaining to the topic on a persistent storage medium.

6. The method of claim 5 wherein the receiving the information and saving the information operations are repeated for a program duration, and wherein the accepting the reservation from the at least one viewer occurs after the program duration has elapsed.

7. The method of claim 1 wherein the reservation from the reporter comprises an expected start time at which the reporter will begin transmitting the information pertaining to the topic.

8. The method of claim 1 wherein the reservation from the reporter comprises an expected program duration for which the reporter will transmit the information pertaining to the topic.

9. The method of claim 1 wherein the reservation from the reporter comprises a geographical location from which the reporter will transmit the information pertaining to the topic.

10. The method of claim 1, further comprising:
receiving a comment from the at least one viewer; and
transmitting the comment to the reporter.

11. The method of claim 10, further comprising:
transmitting the comment to at least one other viewer.

12. The method of claim 1, further comprising:
receiving a comment from the at least one viewer; and
transmitting the comment to at least one other viewer.

13. A system comprising:
a scheduling database to list program items, each program item comprising a date, a time, a topic and a reporter;
a reservation system to accept a new program item from a reporter and insert the new program item into the scheduling database;
a request system to accept a request from a viewer to access a program item in the scheduling database; and
a repeater system to accept information pertaining to a topic of the new program item from the reporter and to transmit the information to the viewer, said repeater system to be activated near a date and time of the new program item.

14. The system of claim 13, further comprising:
an archiving system to store information pertaining to the topic of the new program item from the reporter.

15. The system of claim 14, further comprising:
a menu system to present a list of items in the scheduling database, wherein each item in the list is one of:
an upcoming report item whose time has not yet occurred;
a live report item for which information is presently being received and repeated; or
an archived report item whose information is stored in the archiving system.

16. A computer-readable medium containing instructions to cause a programmable processor to perform operations comprising:
recording schedule items for a plurality of live presentations in a database;
displaying a selected subset of the schedule items based on a search criterion;
recording a reservation from an audience member to view one of the live presentations;
receiving data comprising the one of the live presentations at a corresponding schedule time; and
retransmitting the data comprising the one of the live presentations to the audience member.

17. The computer-readable medium of claim 16 containing additional instructions to cause the programmable processor to perform operations comprising:
recording at least a second reservation from a second audience member to view the one of the live presentations;
retrieving information about the at least two reservations from the database; and
transmitting the information to a presenter of the one of the live presentations.

18. The computer-readable medium of claim 16 containing additional instructions to cause the programmable processor to perform operations comprising:
storing the data comprising the one of the live presentations for later replay.

19. The computer-readable medium of claim 16 containing additional instructions to cause the programmable processor to perform operations comprising:
receiving a comment from the audience member; and
transmitting the comment to a source of the data comprising the one of the live presentations.

20. The computer-readable medium of claim 16 wherein the data comprising the one of the live presentations includes at least two of:
a) live audio data;
b) live video data;
c) pre-recorded audio data;
d) pre-recorded video data; or
e) textual data.
